(19) United States
(12) Patent Application Publication
(10) Pub. No.: US 2006/0232407 A1
(43) Pub. Date: Oct. 19, 2006

(54) Radio frequency detectable assemblies and detectable surgical articles comprising same

(76) Inventor: Marlin Daniel Ballard, Austin, TX (US)

Correspondence Address: DAVID ODELL SIMMONS, 7637 PARKVIEW CIRCLE, AUSTIN, TX, 78731, US

(21) Appl. No.: 11/105,702

(22) Filed: Apr. 14, 2005

(51) Int. Cl. G08B 13/14

(52) U.S. Cl. 340/572.1; 340/572.8

(57) ABSTRACT

A detectable surgical article comprises material configured for at least one of absorbing fluids within a body and packing bodily structures, a radio frequency identification transponder and a transponder attachment structure. The radio frequency identification transponder is configured for emitting a signal designating presence of the radio frequency identification transponder and/or information about the material. The transponder attachment structure is attached to the material. The radio frequency identification transponder is fixedly engaged by the transponder attachment structure. The transponder attachment structure includes a transponder mounting surface and a fabric-engaging surface. The radio frequency identification transponder is mounted on the transponder mounting surface.

### FIELD OF THE DISCLOSURE

The invention relates generally to apparatuses and methods for tracking surgical supplies and, more specifically, to facilitating presence and/or counting of articles capable of absorbing fluids within a body and packing internal bodily structures.

### BACKGROUND

During surgical procedures, articles such as absorbent sponges are employed to soak up blood and other fluids in and around an incision site. In a study entitled “The Retained Surgical Sponge” (Kaiser, et al., The Retained Surgical Sponge, Annals of Surgery, vol. 224, No. 1, pp. 79-84), surgical sponges were found to have been left inside a patient following surgery in 67 of 9729 (0.7%) medical malpractice insurance claims reviewed. In those 67 cases, the mistake was attributed to an incorrect sponge count in seventy-six percent (76%) of the cases studied, and attributed to the fact that no count was performed in ten percent (10%) of the cases studied. Typically, a sponge left inside a patient is presumed to indicate that substandard and negligent care has taken place. Clearly, it is in both a patient's and the health care providers' best interest to account for every surgical sponge used in any particular surgical procedure.

As explained in U.S. Pat. No. 5,923,001 entitled Automatic Surgical Sponge Counter and Blood Loss Determination System, sponge counts are an essential step in operating room procedure. Sponge counts are a difficult procedure for a number of reasons. For example, the handling of soiled sponges carries the risk of transmission of blood borne diseases such as hepatitis B virus (HBV) and human immunodeficiency virus (HIV). Therefore, used sponges are handled with gloves and/or instruments and the handling is kept to a minimum. Another difficulty is that the counting process is typically tedious, time-consuming and frustrating.

Sponge counts are typically performed multiple times during a surgical procedure, both at the beginning and throughout the procedure as sponges are added, before closure of a deep incision or body cavity, and during personnel breaks and shift changes. Thus, within all the activity of an operating room, maintaining an accurate sponge is difficult, as evidenced by the error rate mentioned in the Keiter article, quoted above.

There do exist products to make the procedure both simpler and more reliable. For example, various systems facilitate the hand-counting of surgical sponges by arranging the sponges into visually inspectible groups or arrangements (see U.S. Pat. No. 3,948,390, 4,364,490, 4,784,267, 4,832,198, 4,925,048 and 5,658,077). These systems are problematic because surgeons and anesthesiologists often determine blood loss by means of visual inspection or a manual weighing of soiled sponges and so soiled sponges are typically kept in one area of an operating room during a surgical procedure, thus creating the possibility that groupings are co-mingled or counted twice. In addition, operating room workers are often too rushed, fatigued and/or distracted to accurately count a large number of soiled sponges lumped together in one or more groups. This method also depends upon the accuracy of an initial count and, if the number of sponges in the original package is mislabeled by the manufacturer, then a missing sponge may be missed during a final count.

A second solution to the surgical sponge-tracking problem is the inclusion of a radiopaque thread in the sponges. A radiopaque thread can be identified and located if a sponge is accidentally left inside a patient. Thus, if a patient develops a problem such as an abscess, a bowel obstruction, or internal pain at any time following an operation, a sponge that has been left in the body can be detected by x-ray. Companies that market sponges with radiopaque threads include Johnson & Johnson, Inc. of New Brunswick, N.J., Medline Industries of Mundelein, Ill. and the Kendall Company of Mansfield, Mass.

A third solution to the sponge problem is the inclusion of a radio frequency identification (RFID) tag in each sponge (see U.S. Pat. No. 5,923,001). The RFID tag enables a patient to be scanned to detect the presence of a sponge within a body cavity, but RFID tags may cost several times what a typical surgical sponge costs and are also bulky, impairing the usefulness of the sponge.

Another solution to the sponge problem is a device that counts sponges as they are dropped, one-by-one, into an opening, or “entry gate” of the device (see U.S. Pat. No. 5,629,498). This solution is restricted by the accuracy of the original count and the precision of operating room assistants, as they separate sponges from one another and drop them into the entry gate, one-by-one.

A final, exemplary solution involves attaching a magnetic resonance device, or marker tag, to each sponge, which are then scanned by appropriate equipment (see U.S. Pat. No. 5,057,095 and 5,664,582). The problem with this solution is that both the marker tags and the scanning equipment are expensive and do not necessarily work well in an operating room environment. As acknowledged in the '582 patent, the scanner must be essentially parallel to the marker tag inside a wadded up sponge. If the marker tag is bent or folded, a signal from the tag may be difficult to identify. In addition, the scanning equipment may give false counts if the operating room contains objects, other than the marker, that also generate or respond to magnetic energy.

Many other problems and disadvantages of the prior art will become apparent to one skilled in the art after comparing such prior art with the present invention as described herein.

### SUMMARY OF THE INVENTION

Embodiments of articles in accordance with the present invention enable a surgical team to insure that no surgical article (e.g., a surgical sponge) is left in a patient. Additionally, such articles preclude the need for performing the messy and time-consuming job of individually counting such sponges as they are entered and removed from the surgical site. Articles in accordance with the present invention include a radio frequency identification transponder that emits a signal designating presence of the radio frequency identification transponder and/or information about the material (i.e., the information signal).

In a preferred embodiment, the radio frequency identification transponder includes a memory device (e.g., an integrated circuit) on which such information is maintained and an antenna connected to the memory device for transmitting the information signal in response to receiving an activation signal from a reader device. Through emission of the signal (e.g., via activation by a suitable reader device) from the radio frequency identification transponder and reception of the signal (e.g., via the reader device), the location and/or presence of the article may be identified and information about the article may be acquired. Examples of such information include, but are not limited to, information relating to the size, type or model of the article.

Various embodiments of detection assemblies are disclosed herein. Such detectable assemblies include a RFID transponder in accordance with the present invention and means for facilitating attachment of the RFID transponder to material configured for absorbing fluids within a body and/or packing bodily structures. The usefulness of such detectable is that they permit RFID transponders, which may be relatively small in size, to be reliably, efficiently and consistently attached to such material. Examples of such material configurations include single or multiple layers of material comprised by woven material, non-woven material, foam material and the like. In one example, such material is provided in the form of a surgical sponge.

In one embodiment of the present invention, a detectable surgical article comprises material configured for at least one of absorbing fluids within a body and packing bodily structures and a pre-fabricated detection assembly. The pre-fabricated detection assembly includes a radio frequency identification transponder and a transponder attachment structure. The prefabricated detection assembly is attached to the material. The radio frequency identification transponder is configured for emitting a signal designating presence of the radio frequency identification transponder and/or information about the material. The radio frequency identification transponder is fixedly engaged by the transponder attachment structure.

In another embodiment of the present invention, a detectable surgical article comprises material configured for at least one of absorbing fluids within a body and packing bodily structures, a radio frequency identification transponder and a transponder attachment structure. The radio frequency identification transponder is configured for emitting a signal designating presence of the radio frequency identification transponder and/or information about the material. The transponder attachment structure is attached to the material. The radio frequency identification transponder is fixedly engaged by the transponder attachment structure.

In another embodiment of the present invention, a detectable surgical article comprises material configured for at least one of absorbing fluids within a body and packing bodily structures, a radio frequency identification transponder and a pre-formed body. The radio frequency identification transponder is configured for emitting a signal designating presence of the radio frequency identification transponder and/or information about the material. The pre-formed body is attached to the material and having the radio frequency identification transponder fixedly engaged therewith.

Turning now to specific aspects of the present invention, in at least one embodiment, the transponder attachment structure includes a transponder mounting surface and a fabric engaging surface and the radio frequency identification transponder is mounted on the transponder mounting surface.

In at least one embodiment of the present invention, the pre-fabricated detection assembly includes a bonding material configured for attaching the transponder attachment structure to the material and the bonding material is disposed between the fabric engaging surface and the material.

In at least one embodiment of the present invention, the transponder attachment structure includes a material engagement member extending from the fabric engaging surface and being engaged with the material for securing the transponder attachment structure to the material.

In at least one embodiment of the present invention, the transponder attachment structure includes a transponder mounting surface and the radio frequency identification transponder is mounted on the transponder mounting surface.

In at least one embodiment of the present invention, the pre-fabricated detection assembly includes a bonding material configured for attaching the transponder attachment structure to the material, the radio frequency identification transponder includes opposed major surfaces, a first one of the opposed major surfaces is engaged with the transponder mounting surface and the bonding material is disposed between a second one of the opposed major surfaces and the material.

In at least one embodiment of the present invention, the transponder attachment structure includes a material engagement member engaged with the material for securing the transponder attachment structure to the material.

These and other objects, embodiments advantages and/or distinctions of the present invention will become readily apparent upon further review of the following specification and associated drawings.

### BRIEF DESCRIPTION OF THE FIGURES

FIG. 1 depicts an embodiment of a detectable surgical article system in accordance with the present invention.

FIG. 2 depicts a method for facilitating use of a detectable surgical article in accordance with the present invention.

FIGS. 3A-3C depict various aspects of a first embodiment of a detection assembly in accordance with the present invention.

FIGS. 4A-4B depict various aspects of a second embodiment of a detection assembly in accordance with the present invention.

FIG. 5 depicts a third embodiment of a detection assembly in accordance with the present invention.

### DETAILED DESCRIPTION OF THE FIGURES

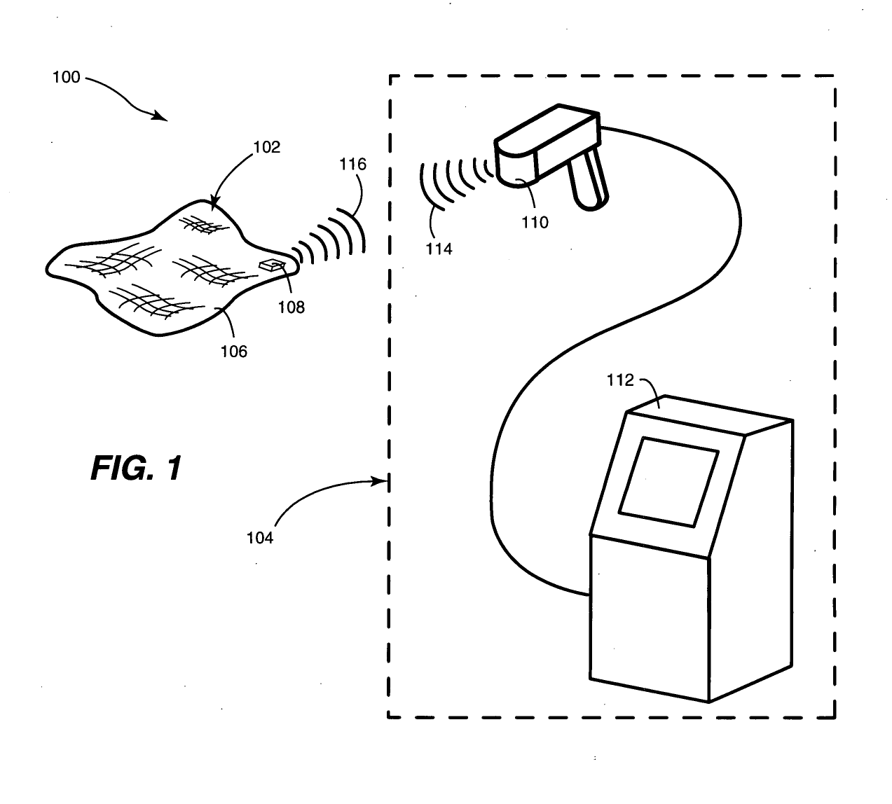

FIG. 1 depicts an embodiment of a detectable surgical article system in accordance with the present invention, generally referred to as the detectable surgical article platform 100. The detectable surgical article platform 100 includes a detectable surgical article 102 and a detection system 104. The detectable surgical article 102 includes a surgical article 106 and a detection assembly 108 attached to the surgical article 106. The detection system 104 includes a reader apparatus 110 and a signal processing apparatus 112 operably interfaced with the reader apparatus 110 (e.g., via a cable or wireless connection).

The detection assembly 108 includes a radio frequency identification (RFID) device that is programmed with information pertaining to the surgical article 106 and its use. A typical RFID device includes an integrated circuit (IC) and an antenna connected to the IC. The IC is configured for having information programmed thereon and the antenna is configured for receiving signals (i.e., radio waves) and generating signals containing at least portions of the information. Examples of the information include carried by a radio frequency identification (RFID) device of a detectable surgical article in accordance with the present invention include, but are not limited to, information relating to the surgical article configuration, information relating to the surgical intended use, information relating to a reference identifier of the surgical article (i.e., a unique identifier) and information relating to the surgical article manufacturer.

The RFID device may be one of many types. In a case where the RFID device of the detection assembly 108 is an active RFID device, the RFID device includes a battery. Power from the battery is used to run the IC's circuitry and to broadcast the information signal to the reader apparatus 110 in response to receiving the activation signal 114 from the reader apparatus 110. In a case where the RFID device of the detection assembly 108 is a passive RFID device, the RFID device does not include a battery. Instead, the IC draws power from the reader, via an induced current by the activation signal 114 in the antenna of the RFID device. In a case where the RFID device of the detection assembly 108 is a semi-passive RFID device, the RFID device has a battery to run the IC's circuitry, but communication is facilitated via power generated from the activation signal 114. RFID devices, reader apparatuses and signal processing apparatuses are commercially available from sources such as, for example, Texas Instruments, W.H. Brady, Elan Microelectronics, TagSys and Hitachi.

Upon receiving the information signal 116, the reader apparatus 110 converts the information signal into a signal that is interpretable by the signal processing apparatus 112. For example, the reader apparatus 110 converts the information signal 116 to a digital data representing the information of the information signal 116, thus producing an interpretable information signal. The signal processing apparatus 112 is a data processing system running one or more sets of instructions (e.g., software) configured for interpreting and processing the interpretable information signal. The signal processing apparatus 112 preferably interprets the interpretable information signal and processes the interpretable information signal. Through such interpretation and processing, information such as, for example, information relating to the surgical article configuration, information relating to the intended use, information relating to a reference identifier of the surgical article (i.e., a unique identifier) and information relating to the surgical article manufacturer are garnished from the information signal 116.

Selected portions of the signal processing apparatus 112 can be implemented in software, hardware, or a combination of hardware and software. Hardware portions of the present invention can be implemented using specialized hardware logic. Software portions (e.g., portions of the transponder information processing process disclosed below) can be stored in a memory and executed by a suitable computing system such as a microprocessor or a personal computer (PC). Furthermore, software of the signal processing apparatus 112, which comprises an ordered listing of executable instructions for implementing logical functions, can be embodied in any computer-readable medium for use by or in connection with the computing system. Thus, it is disclosed herein that the detection system 104 is suitably configured for facilitating functionality such as tracking surgical articles and/or counting surgical articles supplies within an operating room whereby such tracking and/or counting can be implemented in a manner which requires a minimum degree of human effort and a significant degree of accuracy, reliability and efficiency.

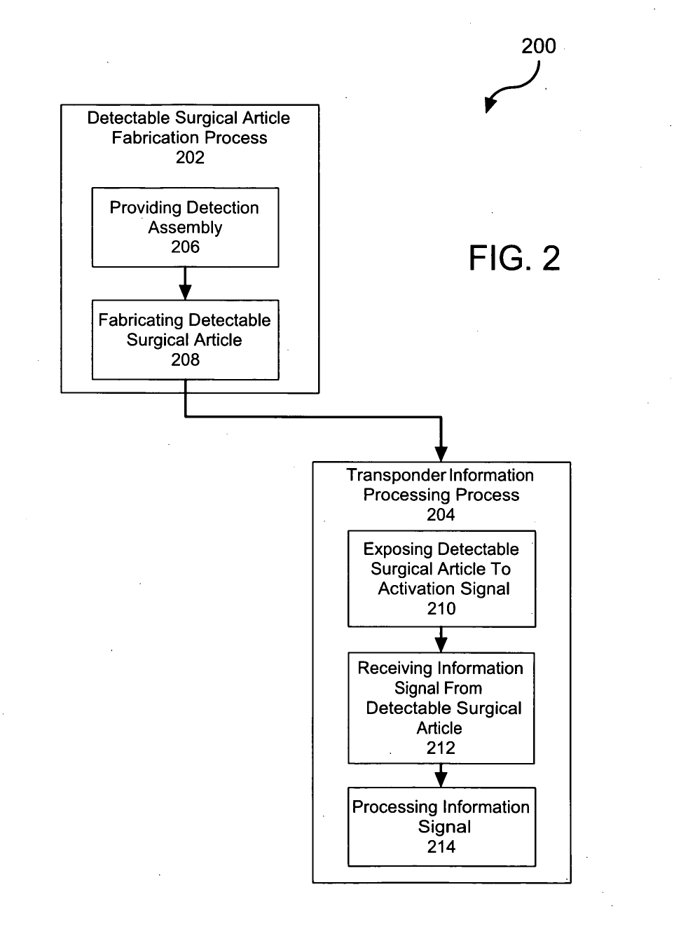

Referring to FIG. 2, a method for facilitating use of a detectable surgical article in accordance with the present invention, which is generally referred to as the method 200, is disclosed. The method 200 includes a detectable surgical article fabrication process 202 and a transponder information processing process 204. The detectable surgical article fabrication process 202 is performed, followed by the transponder information processing process 204 being performed.

The detectable surgical article fabrication process 202 includes an operation 206 for providing a detection assembly and an operation 208 for fabricating a detectable surgical article. As is discussed in greater detail below, the detection assembly includes a programmed RFID transponder and a transponder attachment structure. The programmed RFID transponder is attached to the transponder attachment structure and the transponder attachment structure is configured for being attached to a surgical article. Preferably, the transponder attachment structure is specifically configured for being attached to a surgical sponge. In one embodiment, providing the detection assembly includes purchasing preprogrammed RFID transponders from a suitable vendor. As will be appreciated by a skilled person, conventional approaches for producing programmed RFID transponders are well known in the art and, thus, will not be discussed herein in further detail.

The detection assembly may be attached to a surgical article during any number of operations in the manufacturing process of the surgical article (e.g., a surgical sponge manufacturing process). Examples of such operations include, but are not limited to, material unwind operation, material folding operation (i.e., for producing multiple layers of material from a single layer input material), material stacking operation (i.e., for producing multiple layers of material from a single layer input material), material sewing operation, material cutting operation, sponge inspection operation and sponge packaging operation. Preferably, but not necessarily, the detectable assembly is attached during an operation where the surgical article (e.g. a surgical sponge) is stationary (e.g., stopped for performing an operation) rather than moving. Additionally, as will be appreciated in view of the embodiments of detectable assemblies depicted herein, the detectable assemblies may be provided in any number of different formats. Examples of such formats include, but are not limited to, a roll of attached assemblies, a magazine of discrete assemblies, a magazine of attached assemblies, a magazine of continuous stock (e.g., extruded stock) from which individual detectable object assemblies are segmented and the like.

The transponder information processing process 204 includes an operation 210 for exposing a detectable surgical article (i.e., a RFID transponder of the detectable surgical article) to an activation signal. In a preferred embodiment, the activation signal is transmitted from a reader apparatus, such as the reader apparatus 110 depicted in FIG. 1. In response to the detectable surgical article being exposed to the activation signal, an operation 212 is performed for an information signal being received by a signal processing apparatus (e.g., the signal processing apparatus 112 depicted in FIG. 1) from the detectable surgical article (i.e., the RFID transponder of the detectable surgical article). After receiving the information signal, an operation 214 is performed for processing the information signal. Preferably, but not necessarily, processing the information signal includes interpreting the information signal for determining information relating to a configuration of the surgical article, an intended use of the surgical article, a reference identifier of the surgical article and/or manufacturer of the surgical article.

In one specific embodiment of the present invention, a plurality of detectable surgical articles is exposed to the activation signal. Thereafter each one of the detectable surgical articles emits a respective information signal. Processing of the information signals includes determining a presence and/or location of each one of the detection assemblies and/or determining a number of detection assemblies transmitting an information signal. For example, combined signal strength is used for determining a number of detection assemblies or a reference identifier contained in each one of the information signals is recognized.

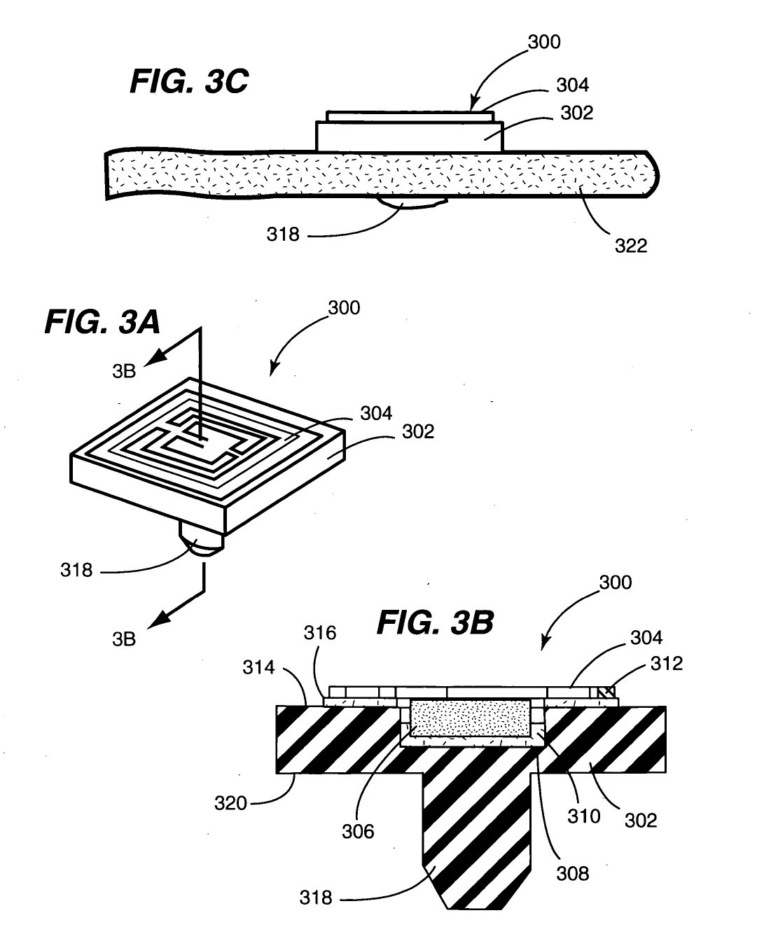

Turning now to specific embodiments of detectable surgical articles and detection assemblies, FIGS. 3A-3C depict a first embodiment of a detection assembly in accordance with the present invention (referred to generally as detection assembly 300). The detection assembly 300 includes a preformed transponder attachment structure 302 (i.e., a body) having a RFID transponder 304 attached thereto. The RFID transponder 304 includes an integrated circuit (IC) 306, which is disposed within a cavity 308 of the pre-formed transponder attachment structure 302. A composition 310 such as, for example, a die bond compound or an adhesive may be disposed in the cavity 308 for limiting movement of the IC 306 relative to the transponder attachment structure 302. An antenna 312 of the RFID transponder 304 is attached to a first major surface 314 of the transponder attachment structure 302 (i.e., a transponder mounting surface) via means such as, for example, adhesive 316. It is disclosed herein that the cavity 308 may be omitted, with the detectable assembly 300 mounted in an inverted manner as depicted.

The transponder attachment structure 302 includes a material engagement member 318 extending from a second major surface 320 of the transponder attachment structure 302 (i.e., a fabric engaging surface). As depicted in FIG. 3C, the material engagement. member 318 is configured for being engaged with material of a surgical sponge 322. The material engagement member 318 extends at least partially through the material of the surgical sponge 322 and is secured to the material by means such as, for example, physical deformation, thermal deformation (e.g., heat stacking), thermal bonding (e.g., ultrasonic welding) of the like.

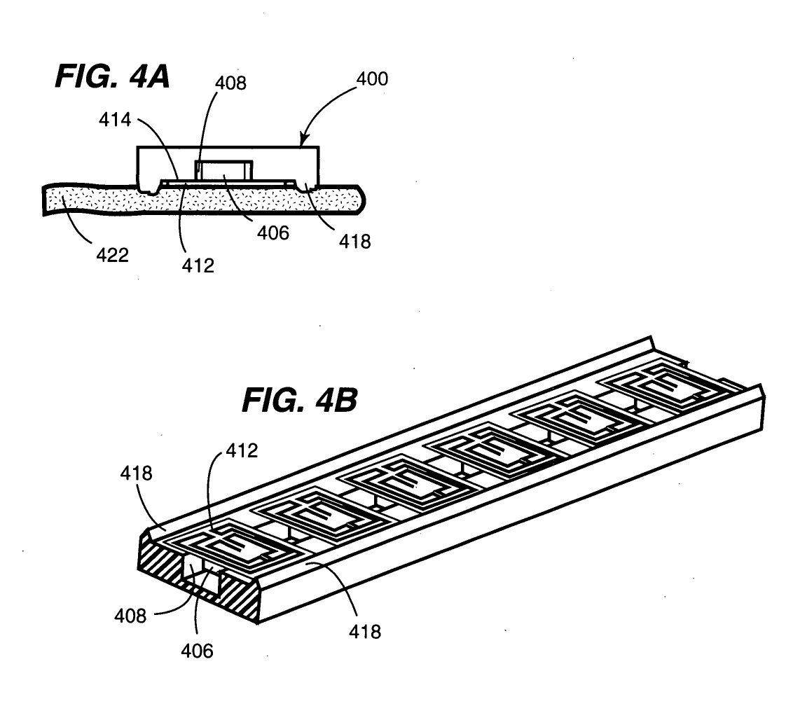

FIGS. 4A depict a second embodiment of a detection assembly in accordance with the present invention (referred to generally as detection assembly 400). The detection assembly 400 includes an extruded transponder attachment structure 402 (i.e., a body) having a RFID transponder 404 attached thereto. As depicted in FIG. 4B, the transponder attachment structure 402 is a segment of an extruded body. A plurality of RFID transponders may be mounted on the extruded body, with the extruded body being subsequently segmented into discrete sections (e.g., one RFID transponder per section).

The RFID transponder 404 includes an integrated circuit (IC) 406, which is disposed within a cavity 408 of the extruded transponder attachment structure 402. A composition such as, for example, a die bond compound or an adhesive may be disposed in the cavity 408 for limiting movement of the IC 406 relative to the transponder attachment structure 402. An antenna 412 of the RFID transponder 404 is attached to a transponder mounting surface 414 of the transponder attachment structure 402 via means such as, for example, adhesive. It is disclosed herein that the cavity 408 may be omitted, with the detectable assembly 400 mounted in an inverted manner as depicted.

The transponder attachment structure 402 includes spaced apart material engagement members 418 extending from the transponder mounting surface 414. As depicted in FIG. 4A, the material engagement members 418 are configured for being engaged with material of a surgical sponge 422. The material engagement members 418 extend at least partially through the material of the surgical sponge 422 and are secured to the material by means such as, for example, physical deformation, thermal deformation (e.g., heat stacking), thermal bonding (e.g., ultrasonic welding) of the like.

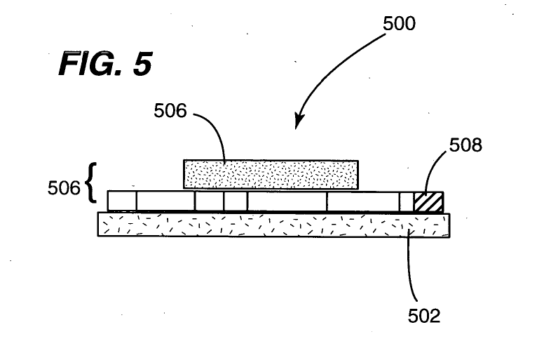

FIG. 5 depicts a third embodiment of a detection assembly in accordance with the present invention (referred to generally as detection assembly 500). The detection assembly 500 includes an attachment material 502 and a RFID transponder 504 attached to the attachment material 502. A bonding material such as, for example, a pressure sensitive adhesive or a heat-activated adhesive is an example of the attachment material 502. The attachment material 502 is configured for being bondable to a surgical article (e.g., material of a surgical sponge) such as by application of heat. The RFID transponder 504 includes an integrated circuit (IC) 506 and an antenna 512 attached to the IC 506.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

I claim:

1. A detectable surgical article, comprising:
material configured for at least one of absorbing fluids within a body and packing bodily structures; and
a pre-fabricated detection assembly including a radio frequency identification transponder and a transponder attachment structure, wherein the detection assembly is attached to said material, wherein the radio frequency identification transponder is configured for emitting a signal designating at least one of presence of the radio frequency identification transponder and information about said material and wherein the radio frequency identification transponder is fixedly engaged by the transponder attachment structure.

2. The detectable surgical article of claim 1 wherein:
the transponder attachment structure includes a transponder mounting surface and a fabric engaging surface; and
the radio frequency identification transponder is mounted on the transponder mounting surface.

3. The detectable surgical article of claim 2 wherein:
the pre-fabricated detection assembly includes a bonding material configured for attaching the transponder attachment structure to said material; and
the bonding material is disposed between the fabric engaging surface and said material.

4. The detectable surgical article of claim 2 wherein the transponder attachment structure includes a material engagement member extending from the fabric engaging surface and being engaged with said material for securing the transponder attachment structure to said material.

5. The detectable surgical article of claim 1 wherein:
the transponder attachment structure includes a transponder mounting surface; and
the radio frequency identification transponder is mounted on the transponder mounting surface.

6. The detectable surgical article of claim 5 wherein:
the pre-fabricated detection assembly includes a bonding material configured for attaching the transponder attachment structure to said material;
the radio frequency identification transponder includes opposed major surfaces;
a first one of said opposed major surfaces is engaged with the transponder mounting surface; and
the bonding material is disposed between a second one of said opposed major surfaces and said material.

7. The detectable surgical article of claim 5 wherein the transponder attachment structure includes a material engagement member engaged with said material for securing the transponder attachment structure to said material.

8. The detectable surgical article of claim 1 wherein the transponder attachment structure includes a material engagement member engaged with said material for securing the transponder attachment structure to said material.

9. A detectable surgical article, comprising:
material configured for at least one of absorbing fluids within a body and packing bodily structures;
a radio frequency identification transponder configured for emitting a signal designating at least one of presence of the radio frequency identification transponder and information about said material; and
a transponder attachment structure attached to said material, wherein the radio frequency identification transponder is fixedly engaged by the transponder attachment structure.

10. The detectable surgical article of claim 9 wherein:
the transponder attachment structure includes a transponder mounting surface and a fabric engaging surface; and
the radio frequency identification transponder is mounted on the transponder mounting surface.

11. The detectable surgical article of claim 10 wherein:
the pre-fabricated detection assembly includes a bonding material configured for attaching the transponder attachment structure to said material; and
the bonding material is disposed between the fabric engaging surface and said material.

12. The detectable surgical article of claim 10 wherein the transponder attachment structure includes a material engagement member extending from the fabric engaging surface and being engaged with said material for securing the transponder attachment structure to said material.

13. The detectable surgical article of claim 9 wherein:
the transponder attachment structure includes a transponder mounting surface; and
the radio frequency identification transponder is mounted on the transponder mounting surface.

14. The detectable surgical article of claim 13 wherein:
the pre-fabricated detection assembly includes a bonding material configured for attaching the transponder attachment structure to said material;
the radio frequency identification transponder includes opposed major surfaces;
a first one of said opposed major surfaces is engaged with the transponder mounting surface; and
the bonding material is disposed between a second one of said opposed major surfaces and said material.

15. The detectable surgical article of claim 13 wherein the transponder attachment structure includes a material engagement member engaged with said material for securing the transponder attachment structure to said material.

16. The detectable surgical article of claim 9 wherein the transponder attachment structure includes a material engagement member engaged with said material for securing the transponder attachment structure to said material.

17. A detectable surgical article, comprising:
material configured for at least one of absorbing fluids within a body and packing bodily structures; and
a radio frequency identification transponder configured for emitting a signal designating at least one of presence of the radio frequency identification transponder and information about said material; and
a pre-formed body attached to said material and having the radio frequency identification transponder fixedly engaged therewith.

18. The detectable surgical article of claim 17 wherein:
the pre-formed body includes a transponder mounting surface and a fabric engaging surface; and
the radio frequency identification transponder is mounted on the- transponder mounting surface.

19. The detectable surgical article of claim 18 wherein:
the pre-fabricated detection assembly includes a bonding material configured for attaching the pre-formed body to said material; and
the bonding material is disposed between the fabric engaging surface and said material.

20. The detectable surgical article of claim 18 wherein the pre-formed body includes a material engagement member extending from the fabric engaging surface and being engaged with said material for securing the pre-formed body to said material.

21. The detectable surgical article of claim 17 wherein:
the pre-formed body includes a transponder mounting surface; and
the radio frequency identification transponder is mounted on the transponder mounting surface.

22. The detectable surgical article of claim 21 wherein:
the pre-fabricated detection assembly includes a bonding material configured for attaching the pre-formed body to said material;
the radio frequency identification transponder includes opposed major surfaces;
a first one of said opposed major surfaces is engaged with the transponder mounting surface; and
the bonding material is disposed between a second one of said opposed major surfaces and said material.

23. The detectable surgical article of claim 21 wherein the pre-formed body includes a material engagement member engaged with said material for securing the pre-formed body to said material.

24. The detectable surgical article of claim 17 wherein the pre-formed body includes a material engagement member engaged with said material for securing the pre-formed body to said material.
